(19) United States
(12) Patent Application Publication
(10) Pub. No.: US 2025/0189846 A1
(43) Pub. Date: Jun. 12, 2025

(54) LIGHTING DEVICE AND DISPLAY DEVICE

(71) Applicant: Sharp Display Technology Corporation, Kameyama City (JP)

(72) Inventors: Nobuyuki TAKAHASHI, Kameyama City (JP); Nobuhisa NAKAJIMA, Kameyama City (JP); Takayoshi TANABE, Kameyama City (JP)

(21) Appl. No.: 18/947,712

(22) Filed: Nov. 14, 2024

(30) Foreign Application Priority Data
Dec. 11, 2023 (JP) 2023-208228

(51) Int. Cl. G02F 1/13357

(52) U.S. Cl. CPC G02F 1/133605; G02F 1/133621

(57) ABSTRACT

A lighting device comprises a light source; and a reflector disposed so as to surround the light source around an axis extending in a first direction, and configured to reflect outgoing light of the light source toward the first direction, wherein the light source includes a first light source element, and a second light source element, and the first and second light source elements are arranged in the first direction in a stated order.

### CROSS-REFERENCE TO RELATED APPLICATION

The present application claims priority from Japanese Application JP2023-208228, the content of which is hereby incorporated by reference into this application.

### BACKGROUND

### 1. Field

The present technique relates to a lighting device and a display device.

A known lighting device includes two kinds of light source elements having different emission wavelengths. For example, Japanese Unexamined Patent Application Publication No. 2010-287871 describes a light-emitting device (lighting device) that includes the following: a substrate; and a plurality of white LEDs and a plurality of infrared LEDs linearly and alternately arranged on the substrate. Japanese Unexamined Patent Application Publication No. 2010-287871 describes that this configuration reduces luminosity variations of the white light and infrared light in the column direction (linear direction), thus achieving highly uniform emission intensity.

### SUMMARY

In a lighting device that includes two kinds of light source elements arranged linearly and alternately, light emitted in the direction of the LED arrangement is blocked by adjacent LEDs of another kind. The blocked light does not exit outside the lighting device; hence, light radiated from the lighting device may possibly exhibit uneven distribution.

The present technique has been accomplished based on the above problem. It is an object of the present technique to provide a lighting device that includes two kinds of light source elements, and that can radiate more uniformly distributed light from each of the light source elements.

(1) A lighting device includes the following: a light source; and a reflector disposed so as to surround the light source around an axis extending in a first direction, and configured to reflect outgoing light of the light source toward the first direction. The light source includes a first light source element, and a second light source element. The first and second light source elements are arranged in the first direction in the stated order.

If the second light source element is between the first light source element and the reflector, the outgoing light traveling from the first light source element to the reflector is partly blocked by the second light source element. Since part of the outgoing light does not reach the reflector, reflected light coming from the first light source element is distributed unevenly.

In the configuration of the present disclosure, the second light source element is disposed in a location deviating in the first direction from the first light source element. As such, light emitted from the first light source element and traveling to the reflector reaches the reflector without being blocked by the second light source element and reflects toward the first direction. Since the outgoing light of the first light source element is not blocked by the second light source element, the reflected light traveling in the first direction from the reflector can be distributed uniformly.

(2) In the lighting device described in (1), the second light source element may be mounted on the first light source element. This reduces the mounting area for the light source elements, so that the light source can be downsized.

(3) In the lighting device described in (1) or (2), the emission wavelength of the second light source element may be different from the emission wavelength of the first light source element. This enables light having different wavelengths to be uniformly distributed individually.

(4) In the lighting device described in any one of (1) to (3), the light source may include a housing portion housing the first and second light source elements, and the housing portion may be filled with a fluorescent material configured to subject the outgoing light of at least one of the first and second light source elements to wavelength conversion.

This enables the fluorescent material to perform wavelength conversion on light emitted from one or both of the light source elements, thereby radiating light.

(5) In the lighting device described in (4), the first light source element may be a blue LED configured to emit blue light, the second light source element may be an infrared LED configured to emit infrared light, and the fluorescent material may covert the blue light into white light.

This converts blue light into white light for radiation and radiates infrared light as it is. Both visible light (white light) and invisible light (infrared light) can be radiated.

(6) The lighting device described in (1) to (5) may include a reflective layer disposed between the first and second light source elements, and configured to reflect light.

Accordingly, light radiated in the first direction from the first light source element reflects on the reflective layer. The reflected light changes direction and exits from the light source. Light radiated from the first light source element and blocked by the second light source element decreases, and light that can exit outside the light source increases. Consequently, the light from the first light source element can be used efficiently.

The technique described in the Specification enables a lighting device that includes two kinds of light source elements to radiate more uniformly distributed light from each of the light source elements.

### BRIEF DESCRIPTION OF THE DRAWINGS

FIG. 1 is a side view of a liquid crystal display device according to a first embodiment that is installed;

FIG. 2 is an exploded perspective view of the liquid crystal display device according to the first embodiment;

FIG. 3 is a cross-sectional view of the liquid crystal display device according to the first embodiment taken along line I-I;

FIG. 4 is a cross-sectional view of a multichip LED according to the first embodiment;

FIG. 5 is a plan view of the multichip LED according to the first embodiment;

FIG. 6 is a bottom view of the multichip LED according to the first embodiment;

FIG. 7 illustrates the distribution of light emitted from a lighting device according to the first embodiment;

FIG. 8 is a cross-sectional view of a multichip LED according to a second embodiment; and

FIG. 9 illustrates the distribution of light emitted from a lighting device according to a known configuration.

### DETAILED DESCRIPTION OF EMBODIMENTS

### First Embodiment

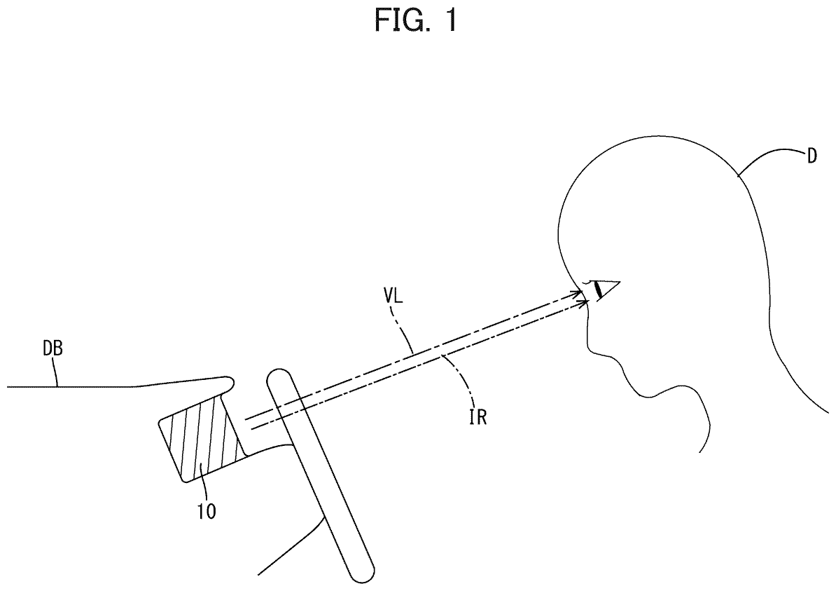

A first embodiment of the present disclosure will be described with reference to FIGS. 1 to 7. The present disclosure addresses, by way of example, a liquid crystal display device 10 (an example of a display device) for use in an instrument panel that is mounted on a vehicle. Some of the drawings show X-, Y-, and/or Z-axes; here, the directions of the individual axes are common throughout the drawings.

### 1. Overall Configuration

As illustrated in FIG. 1, the liquid crystal display device 10 according to this embodiment is installed in front of a driver's seat on a dashboard DB of a vehicle. The liquid crystal display device 10 radiates two kinds of light, i.e., visible light VL and invisible, infrared light IR, toward a driver D. The visible light VL is light for allowing the driver D to visually recognize displays (e.g., various meters and warnings) on a liquid crystal panel 20, which will be described later on. The invisible, infrared light IR is light that is radiated toward the driver D in order to recognize the driver's facial expression or the movement of the driver's eyeballs for the purpose of, for example, preventing drowsy driving. It is noted that a separately provided infrared camera recognizes the facial expression or the movement of the eyeballs of the driver D.

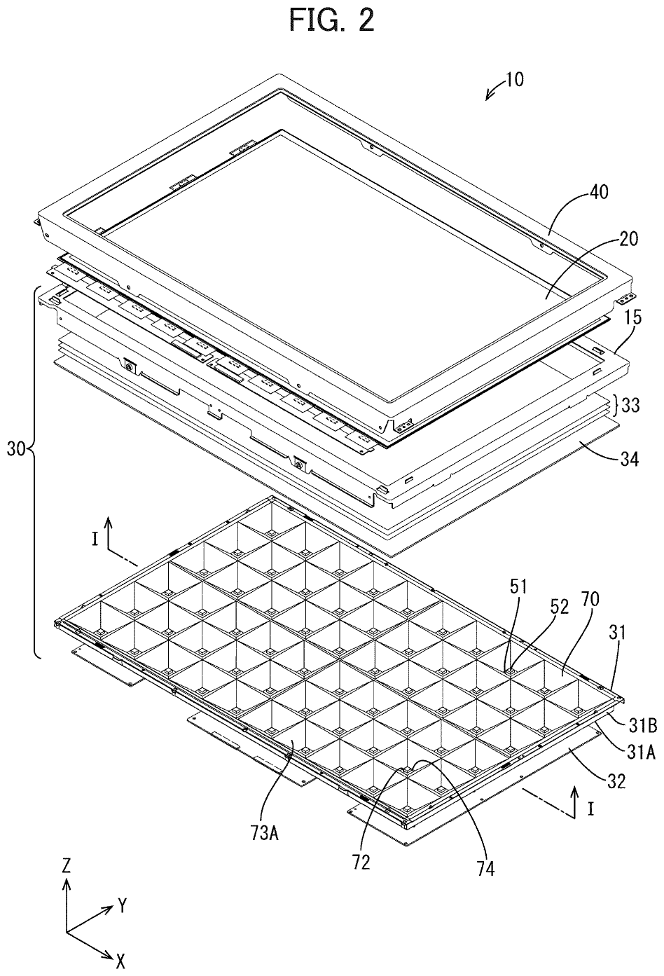

As illustrated in FIG. 2, the liquid crystal display device 10 includes the liquid crystal panel 20 (an example of an object to be irradiated), which is a display panel, and a backlight device 30 (an example of a lighting device) configured to irradiate the liquid crystal panel 20 with light. These components are integrally held by, but not limited to, a bezel 40 having a frame shape. The bezel 40 extends along the periphery of the front side of the liquid crystal panel 20 and constitutes the appearance of the front side of the liquid crystal display device 10. The bezel 40 is made of metal or resin with excellent rigidity.

The liquid crystal panel 20 is assembled to the bezel 40 in such a manner that its display surface, which can display an image, faces the front side. The liquid crystal panel 20 has a horizontally long quadrangular (rectangular) shape as a whole. The liquid crystal panel 20 has a pair of transparent (highly light-transparent) glass substrates bonded together with a predetermined gap therebetween, and a liquid crystal layer sealed between the glass substrates.

One of the glass substrates includes, but not limited to, a switching element (e.g., a TFT) connected to a source wire and a gate wire orthogonal to each other, a pixel electrode connected to the switching element, and an alignment film. The other glass substrate includes, but not limited to, a color filter with, for instance, R (red), G (green), and B (blue) portions arranged in a predetermined array, a counter electrode, and an alignment film.

Among them, the source wire, gate wire, counter electrode, and other things are supplied with image data and various control signals necessary for displaying an image from a driving circuit board (not shown). It is noted that a polarizing plate (not shown) is disposed outside the glass substrates.

As illustrated in FIG. 2, the backlight device 30 includes the following: a chassis 31 substantially box-shaped and having an opening facing a direction where light is emitted (i.e., toward the liquid crystal panel 20); a diffuser plate 34 disposed so as to cover the opening of the chassis 31; an optical sheet 33 configured to give a predetermined optical action to light radiated from the diffuser plate 34; and a frame 15 arranged along the perimeter of the chassis 31, and sandwiching and holding, together with the chassis 31, the perimeter of the diffuser plate 34 and the perimeter of the optical sheet 33.

The chassis 31 houses multichip LEDs 52 (an example of light sources) arranged immediately under the diffuser plate 34 to face the diffuser plate 34, a mounting board 51 on which the multichip LEDs 52 are mounted, and a sheet-shaped reflector 70 configured to reflect light within the chassis 31 toward the diffuser plate 34. As described above, the backlight device 30 according to this embodiment is a so-called directly-under backlight device, in which the multichip LEDs 52 are arranged on the lower side (back side) of the liquid crystal panel 20 to face the panel's back side.

The chassis 31 is made of metal and has, as a whole, a shallow substantial box shape having an opening facing the front side, as illustrated in FIG. 2. The chassis 31 has a bottom portion 31A having a horizontally long quadrangular shape, like the liquid crystal panel 20, and side portions 31B each extending from a corresponding one of the outer ends of the individual sides of the bottom portion 31A toward the front side. On the outside on the back side of the bottom portion 31A is boards 32, including a control board configured to supply a driving signal to the liquid crystal panel 20.

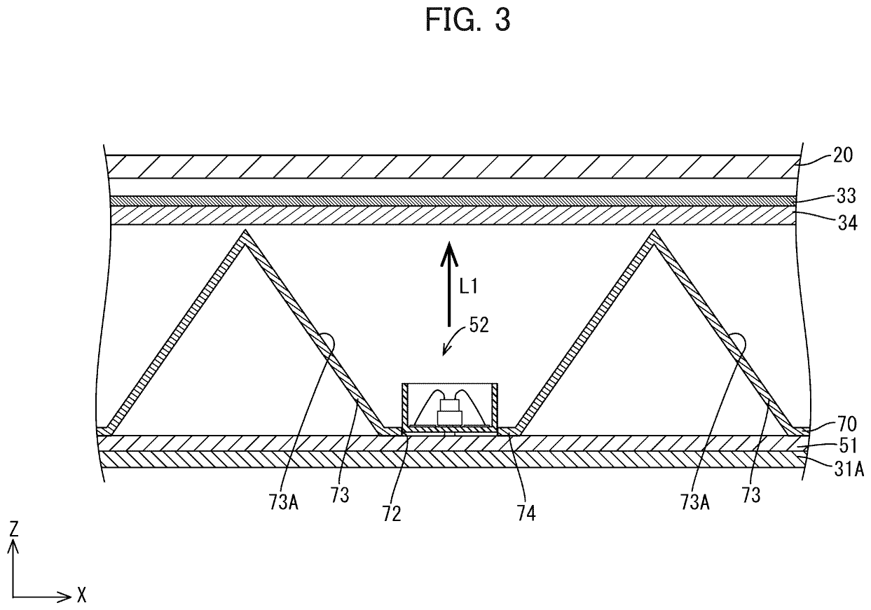

The multichip LEDs 52 are mounted on one of a pair of plate surfaces of the plate-shaped mounting board 51 facing the liquid crystal panel 20 (hereinafter, referred to as a mounting surface). As illustrated in FIG. 2, the multichip LEDs 52 are arranged in parallel in rows and columns (in matrix) at substantially regular intervals in the X-axis direction (row direction) and the Y-axis direction (column direction). The direction of the liquid crystal panel 20 viewed from the multichip LEDs 52 will be referred to as a first direction L1 (see FIG. 3). In this embodiment, the first direction L1 is a direction of the normal to the liquid crystal panel 20 and is parallel to the Z-axis.

The plurality of multichip LEDs 52 are electrically connected to each other by a wire pattern formed from a metal film routed in the mounting surface. The base material of the mounting board 51 is made of metal, such as aluminum, and has a surface on which a wire pattern is formed with an insulating layer interposed therebetween. Upon receiving electric power through the wire pattern, the multichip LEDs 52 emit light. The base material of the mounting board 51 can be made of an insulating material, such as synthetic resin. The configuration of the multichip LEDs 52 will be detailed later on.

As illustrated in FIGS. 2 and 3, the reflector 70 has insertion holes 72, side walls 73, and bottom walls 74. Each of the plurality of multichip LEDs 52 is inserted in a single insertion hole 72. Each side wall 73 is formed so as to surround the corresponding multichip LED 52 inserted in the insertion hole 72. Each bottom wall 74 is between the corresponding insertion hole 72 and side wall 73 and is formed along the mounting board 51.

The side wall 73 consists of four inclined surfaces 73A inclined and protruding from the mounting board 51 to the front side. These four trapezoidal inclined surfaces 73A surround a single multichip LED 52 in the form of an inverted quadrangular pyramid to constitute the individual side wall 73. The four trapezoidal inclined surfaces 73A surround the corresponding multichip LED 52 individually in the form of an inverted quadrangular pyramid.

Light radiated from each multichip LED 52 and reached the inclined surfaces 73A is reflected by the inclined surfaces 73A so as to be directed in the first direction L1 (i.e., to the front side or liquid crystal panel 20). The degree of directivity in the first direction L, or other things can be adjusted by regulating the angle of the inclined surfaces 73A of the side wall 73 in accordance with such an alignment characteristic of the multichip LED 52 that the intensity of outgoing light peaks.

In this embodiment, the multichip LEDs 52 are arranged at constant intervals, and the side walls 73 surrounding the plurality of individual multichip LEDs 52 have an equal size. Light radiated from each multichip LED 52 is directed toward the liquid crystal panel 20 by the inclined surfaces 73A of the side wall 73.

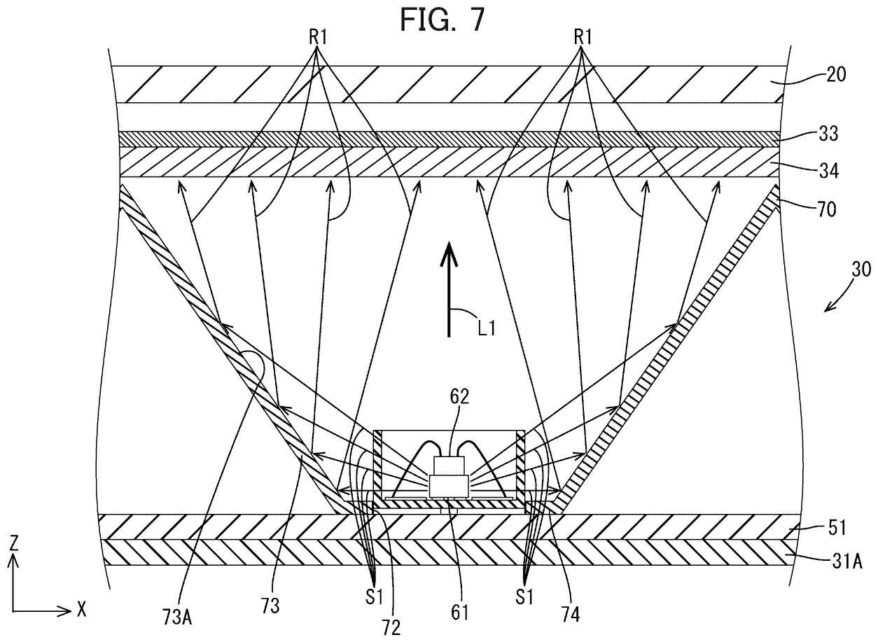

Here, the wording “reflected so as to be directed in the first direction (reflected toward the first direction)” includes not only a case where reflected light is in parallel to the first direction L1, but also a case where the component of reflected light in the first direction L1 increases when compared with that before reflection. To be specific, FIG. 7 illustrates that outgoing light S1 from the multichip LED 52 reflects on the reflector 70 and changes direction, and that reflected light R1 enters the liquid crystal panel 20. The reflected light R1 does not enter the liquid crystal panel 20 perpendicularly in some cases, but the component of the reflected light R1 in the first direction L1 is larger than that of the outgoing light S1 before the reflection. Such reflection is encompassed in the wording “reflected toward the first direction”.

### 2. Configuration of Multichip LED

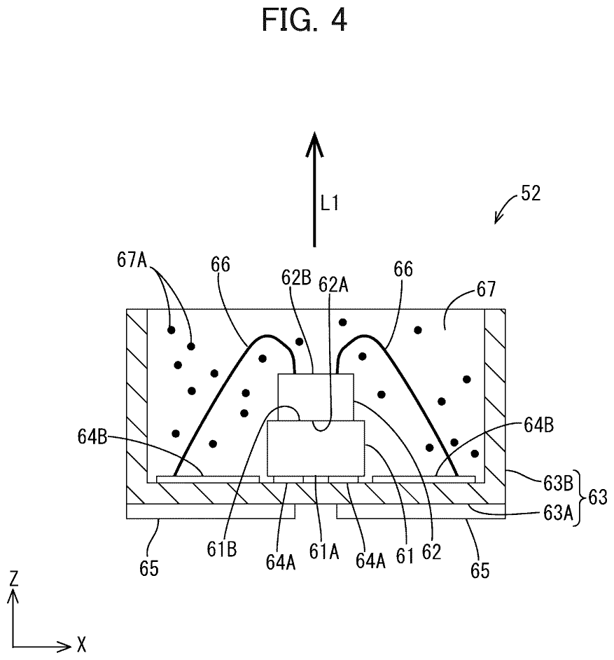

The liquid crystal display device 10 is a display device that can radiate both of the visible light VL and infrared light IR toward the driver D. The multichip LED 52 used in the liquid crystal display device 10 emits two kinds of light, i.e., white light, which is visible light, and infrared light. The configuration of the multichip LED 52 will be described with reference to FIGS. 4 to 7.

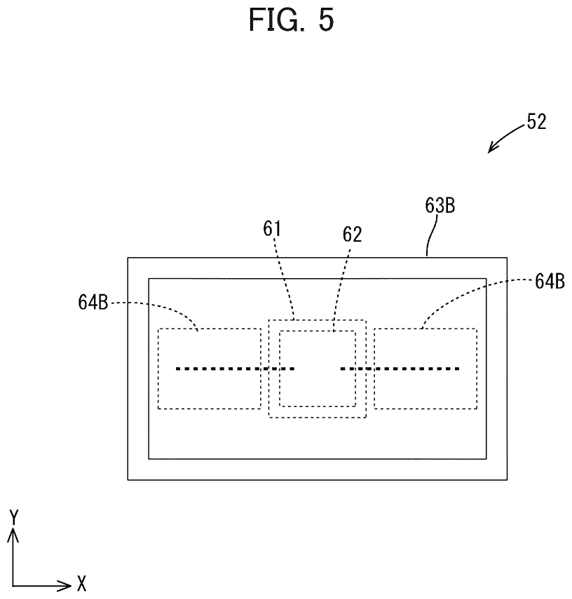

As illustrated in FIGS. 4 and 5, the multichip LED 52 includes two light source elements (i.e., a first light source element 61 and a second light source element 62). The first light source element 61 is an LED chip configured to emit blue light. The second light source element 62 is an LED chip configured to emit light (in this embodiment, infrared light) having a wavelength different from that of the blue light emitted from the first light source element 61.

The multichip LED 52 includes a housing portion 63 housing the two light source elements 61 and 62, and a seal portion 67 filled in the housing portion 63 and sealing the two light source elements 61 and 62 in the housing portion 63. The housing portion 63 is a so-called package, having a box shape with an opening facing the liquid crystal panel 20.

The housing portion 63 has a bottom portion 63A parallel to the plate surfaces of the mounting board 51, and a side portion 63B extending in the Z-axis direction from the perimeter of the bottom portion 63A. The housing portion 63 is made of transparent resin (with high light transparency) in its entirety and transmits visible light and infrared light.

The housing portion 63 incorporates four internal electrodes (i.e., two internal electrodes 64A and two internal electrodes 64B) formed on the bottom portion 63A. The two internal electrodes 64B are located close to the side portion 63B (near the outer edge) on the bottom portion 63A. The two internal electrodes 64A are located closer to the inside than the internal electrodes 64B (near the center of the bottom portion 63A).

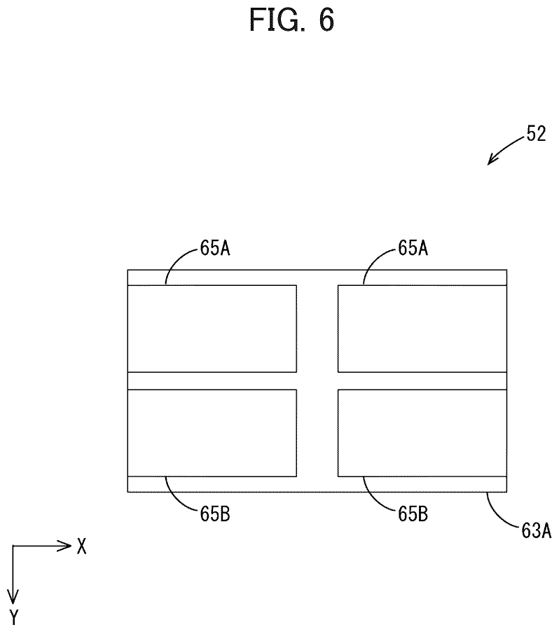

As illustrated in FIG. 6, four external electrodes (i.e., two external electrodes 65A and two external electrodes 65B) are formed on a surface of the bottom portion 63A facing the mounting board 51. The internal electrodes 64A and the external electrodes 65A are electrically one-to-one connected together by wires formed in the housing portion 63, and the internal electrodes 64B and the external electrodes 65B are electrically one-to-one connected together by wires formed in the housing portion 63. The internal electrodes 64A and 64B and the external electrodes 65A and 65B are formed by subjecting the surface of the housing portion 63 to silver plating.

### 2.1. First Light Source Element

As illustrated in FIG. 4, the first light source element 61 has a substantial plate shape or a substantial rectangular-parallelepiped shape and has a first surface 61A and a second surface 61B paired with the first surface 61A. The first surface 61A is oriented toward the bottom portion 63A, and the second surface 61B is oriented toward the second light source element 62 and the liquid crystal panel 20. The first surface 61A includes an anode electrode and a cathode electrode.

The first light source element 61 is mounted in the housing portion 63 in such a manner that the first surface 61A faces the bottom portion 63A. The two internal electrodes 64A on the bottom portion 63A are electrically connected to the anode and cathode electrodes formed on the first surface 61A of the first light source element 61 by the use of, for instance, a conductive adhesive. Applying electric power to the external electrodes 65A as appropriate supplies electric power to the first light source element 61 via the internal electrodes 64A, thus causing the first light source element 61 to emit blue light.

### 2.2. Second Light Source Element

The second light source element 62 is placed on the second surface 61B, which is a surface oriented toward the liquid crystal panel 20 of the first light source element 61. The first light source element 61 and the second light source element 62 are arranged in the first direction L1 in the stated order. The second light source element 62 has a substantial plate shape or a substantial rectangular-parallelepiped shape and has a pair of plate surfaces, i.e., a first surface 62A and a second surface 62B both being substantially flat.

The first surface 62A is a surface facing the second surface 61B of the first light source element 61. The second light source element 62 is fixed on the second surface 61B with, for instance, an adhesive so as not to be misaligned with respect to the first light source element 61.

The second surface 62B includes an anode electrode and a cathode electrode. Each of the electrodes is electrically connected to the corresponding internal electrode 64B via a lead wire 66. Applying electric power to the external electrodes 65B (see FIG. 6) supplies electric power to the second light source element 62 via the internal electrodes 64B, thus causing the second light source element 62 to emit light in an infrared wavelength region.

The emitted light travels toward the liquid crystal panel 20 directly or after reflected by the reflector 70, and as illustrated in FIG. 1, the infrared light IR passed through the liquid crystal panel 20 is radiated to the driver D.

### 2.3 Seal Portion

As illustrated in FIG. 4, the seal portion 67 contains a resin material with high light transparency, and fluorescent materials 67A blended in the resin material at a predetermined distribution concentration. The fluorescent materials 67A convert the wavelength of part of the blue light emitted from the first light source element 61. The fluorescent materials 67A include a green fluorescent material configured to convert the blue light into green light having a green wavelength region, and a red fluorescent material configured to wavelength-convert the blue light into red light having a red wavelength region.

The blue light emitted from the first light source element 61 is converted into green light partly and red light partly by the fluorescent materials 67A while passing through the seal portion 67. The green light and the red light are mixed with the original blue light to exhibit white, so that the multichip LED 52 radiates white light.

It is noted that the fluorescent materials 67A do not affect light having an infrared wavelength region and emitted from the second light source element 62. The light emitted from the second light source element 62 is radiated outside the multichip LED 52 while maintaining the wavelength (infrared wavelength) at the time of the emission.

### 2.4 White-Light Distribution Characteristic

The first light source element 61 has such a light distribution characteristic that all the surfaces but the first surface 61A, facing the mounting surface, emit light, and that the emitted light spreads radially from the individual surfaces. In the configuration according to this embodiment, the second light source element 62 is provided on the second surface 61B (a surface adjacent to the liquid crystal panel 20) of the first light source element 61, as illustrated in FIG. 7. The second light source element 62 does not transmit the blue light of the first light source element 61. Hence, much of the light emitted from the second surface 61B of the first light source element 61 is blocked by the second light source element 62.

The light emitted from the side surfaces (surfaces other than the first surface 61A and second surface 61B) of the first light source element 61 radiates radially from the individual surfaces, and much of the emitted light enters the side wall 73. The light emitted from the individual surfaces of the first light source element 61 a little enters the liquid crystal panel 20 directly; most of it enters the side wall 73.

As illustrated in FIG. 7, most of the light emitted from the first light source element 61 is light that has a component perpendicular to the first direction L1 (the side-to-side direction in FIG. 7), and that is radiated outside the multichip LED 52 as the outgoing light S1. The outgoing light S1 is white light whose wavelength has been converted by the fluorescent materials 67A. The outgoing light S1 enters the side wall 73 without directly entering the liquid crystal panel 20.

Upon entering the side wall 73, the outgoing light S1 reflects on the side wall 73 to change direction, thus turning into the reflected light R1. The reflected light R1, whose component in the first direction L1 is larger than that of the outgoing light S1, enters the liquid crystal panel 20.

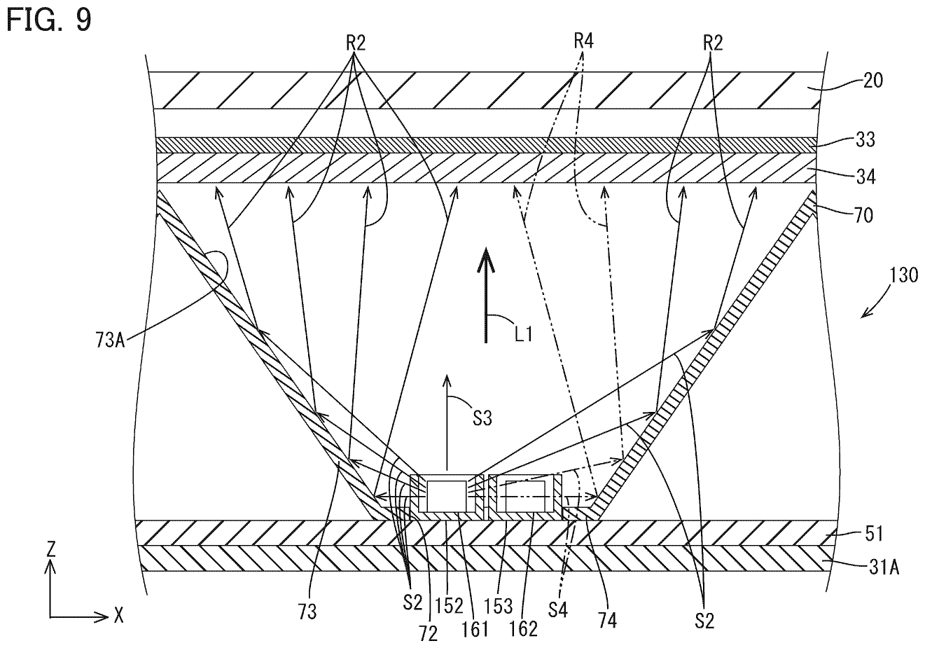

Here, a backlight device 130 having a configuration different from that according to this embodiment will be described for the sake of comparison. FIG. 9 illustrates that the backlight device 130 includes two chip LEDs: a first chip LED 152 and a second chip LED 153 both mounted on the mounting board 51. The first chip LED 152 and the second chip LED 153 are arranged on the same mounting surface with a space therebetween.

The first chip LED 152 includes a first light source element 161 (blue LED), and the second chip LED 153 includes a second light source element 162 (red LED). The first light source element 161 and the second light source element 162 emit light at mutually different wavelengths. Each of the first light source element 161 and second light source element 162 does not transmit light. The light emitted from the first light source element 161 undergoes wavelength conversion by the fluorescent materials 67A, and the light radiated from the first chip LED 152 is white light.

The light radiated from the first light source element 161 will be referred to as outgoing light S2, outgoing light S3, and outgoing light S4. The outgoing light S2 is outgoing light that reaches the reflector 70. The outgoing light S2 reaches the reflector 70 directly because no object blocking light is on the optical path of the outgoing light S2. The outgoing light S2 reached the reflector 70 turns into reflected light R2 that reflects toward the first direction L1, and the reflected light R2 enters the liquid crystal panel 20.

The outgoing light S3 is outgoing light that radiates from the first light source element 161, followed by entering the liquid crystal panel 20 directly. The outgoing light S3 enters the liquid crystal panel 20 directly because no object blocking the optical path of the outgoing light S3 is in the first direction L1 starting from the first light source element 161.

The outgoing light S4, denoted by a chain double-dashed line, is outgoing light whose optical path is blocked by the second light source element 162. The first light source element 161 and the second light source element 162 are mounted side by side on the mounting surface of the mounting board 51. The second light source element 162 is between the first light source element 161 and the side wall 73 located on the right of the first light source element 161 in FIG. 9. The outgoing light S4, traveling from the second light source element 162 toward the right side wall 73, is blocked by the second light source element 162 and thus does not reach the reflector 70. Hence, reflected light R4 (this light, which does not reflect actually, is denoted by a chain double-dashed line) does not enter the liquid crystal panel 20.

In the configuration in FIG. 9, the reflected light R2 and the outgoing light S3 travel in the first direction L1 and enter the liquid crystal panel 20 to raise the brightness of the liquid crystal panel 20, whereas the outgoing light S4 is blocked by the second light source element 162, and the outgoing light S4 does not thus change direction to the first direction L1 and does not enter the liquid crystal panel 20. That is, although the outgoing light S2 and the outgoing light S4 are light emitted from the same side surface, one of them is blocked, and the other reflects and travels to the liquid crystal panel 20, depending on the direction of radiation.

As such, the liquid crystal panel 20 has lower brightness in a region corresponding to the optical path of the reflected light R4 than its surroundings. In the backlight device 130, the white light is distributed unevenly on the liquid crystal panel 20.

### 3. Effects of First Embodiment

(1) The backlight device 30 according to this embodiment includes the multichip LED 52, and the reflector 70 disposed so as to surround the multichip LED 52 around an axis extending in the first direction L1, and configured to reflect the outgoing light S1 of the multichip LED 52 toward the first direction L1. The multichip LED 52 includes the first light source element 61 and the second light source element 62. The first light source element 61 and the second light source element 62 are arranged in the first direction L1 in the stated order.

In the backlight device 30, the two light source elements 61 and 62 are arranged in the first direction L1. In other words, the second light source element 62 is disposed in a location deviating in the first direction L1 from the first light source element 61. Accordingly, the outgoing light S1, traveling from the first light source element 61 to the reflector 70, reaches the reflector 70 without being blocked by the second light source element 62 and reflects toward the first direction L1.

In such a configuration, the outgoing light S1, traveling from the first light source element 61 to the reflector 70, is not blocked by the second light source element 62 regardless of the direction of radiation. This enables the reflected light R1, traveling toward the first direction L1, to be distributed uniformly.

It is noted that the second light source element 62 is disposed with a deviation in the first direction L1 from the first light source element 61. The light emitted from the second light source element 62 reflects on the reflector 70 directly or without being blocked by the first light source element 61 and travels toward the first direction L1. The light emitted from the second light source element 62 is not blocked by the other light source element (first light source element 61) and is hence not distributed unevenly.

The configuration according to this embodiment enables both of the light emitted from the first light source element 61 and the light emitted from the second light source element 62 to be distributed uniformly in the first direction L1.

(2) In the backlight device 30, the second light source element 62 is mounted on the first light source element 61. This reduces the mounting area when compared with mounting the two light source elements 61 and 62 individually, so that the multichip LED 52 can be downsized.

(3) In the backlight device 30, the emission wavelength of the first light source element 61 and the emission wavelength of the second light source element 62 are different wavelengths. This enables the backlight device 30 to uniformly distribute light at different wavelengths individually.

(4) The multichip LED 52 includes the housing portion 63 housing the first light source element 61 and second light source element 62. The housing portion 63 is filled with the fluorescent materials 67A configured to subject the outgoing light S1 of the first light source element 61 to wavelength conversion. This enables the light emitted from the first light source element 61 to undergo wavelength conversion into different-wavelength light that is radiated as the outgoing light S1.

(5) The first light source element 61 is a blue LED configured to emit blue light, the second light source element 62 is an infrared LED configured to emit infrared light, and the fluorescent materials 67A subject the blue light to wavelength conversion into white light. This can radiate both of the white light, which can be visually recognized and whose coloration can be distinguished, and the infrared light, which is visually unrecognizable, invisible light.

### Second Embodiment

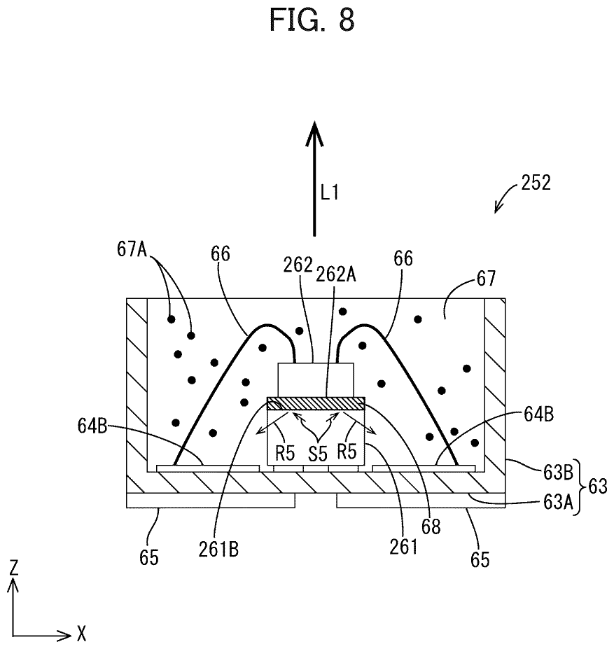

FIG. 8 illustrates the configuration of a multichip LED 252 applied to a lighting device according to a second embodiment. The lighting device according to the second embodiment is different from that according to the first embodiment in that a reflective layer 68 is provided between a first light source element 261 and a second light source element 262 both included in the multichip LED 252. The second embodiment will omit duplicate description about configurations, actions and effects that are similar to those in the first embodiment.

As illustrated in FIG. 8, the multichip LED 252 includes the reflective layer 68 between the first light source element 261 and the second light source element 262. The reflective layer 68 is formed from, for example, a white resin plate with a high reflectance of white light. The reflective layer 68 is provided between a second surface 261B of the first light source element 261 and a first surface 262A of the second light source element 262. The reflective layer 68 is made of resin by way of example; a mirror-finished metal plate, a mirror-finished metal-plated resin plate, a mirror-finished metal-plated layer, or other things may be used.

The first light source element 261 emits outgoing light S5 from the second surface 261B. The outgoing light S5 is reflected by the reflective layer 68 to change direction and is radiated as reflected light R5 from the side surfaces of the first light source element 261. The reflected light R5 passes through the housing portion 63 to exit outside the multichip LED 252 and is then reflected by the reflector 70, to travel toward the first direction L1 and enter the liquid crystal panel 20.

The configuration according to the second embodiment can change the direction of the outgoing light S5, radiated from the first light source element 261 toward the first direction L1, to thus radiate the outgoing light S5 outside the multichip LED 252. This can reduce light radiated from the first light source element 261, and blocked by the second light source element 262 to be thus unable to exit, so that more light can be radiated. Consequently, the light emitted from the first light source element 261 can be used more efficiently.

### Other Embodiments

The present disclosure is not limited to the embodiments described in the forgoing along with the drawings. The following embodiments for instance are also encompassed in the technical scope of the present disclosure.

(1) The second light source element 62 does not have to be mounted on the first light source element 61. The first light source element 61 and the second light source element 62 need to be arranged in the first direction L1 in the stated order.

(2) The emission wavelengths of the first light source element 61 and second light source element 62 may be different or identical. An equal emission wavelength can further enhance the intensity of radiated light.

(3) The fluorescent materials 67A do not have to be filled in the housing portion 63 of the multichip LED 52.

(4) The first light source element 61 is not limited to a blue LED, and the second light source element 62 is not limited to an infrared LED. An LED having any emission wavelength is applicable.

(5) The liquid crystal panel 20, although described as being quadrangular (rectangular) in the foregoing embodiments by way of example, is not limited to a quadrangular shape. A shape having a curved line as its contour line, such as a circle and an ellipse, may be used, or a shape with a combination of a curved line and a straight line may be used.

(6) Each of the first light source element 61 and second light source element 62, although described as being a semiconductor LED chip by way of example, may be another kind of light source element, such as an organic EL element.

(7) The first direction L1, although described as being perpendicular to the display surface of the liquid crystal panel 20 in the foregoing embodiments by way of example, may be inclined with respect to the display surface of the liquid crystal panel 20.

What is claimed is:

1. A lighting device comprising:
a light source; and
a reflector disposed so as to surround the light source around an axis extending in a first direction, and configured to reflect outgoing light of the light source toward the first direction,
wherein the light source includes
a first light source element, and
a second light source element, and
the first and second light source elements are arranged in the first direction in a stated order.

2. The lighting device according to claim 1, wherein the second light source element is mounted on the first light source element.

3. The lighting device according to claim 1, wherein an emission wavelength of the second light source element is different from an emission wavelength of the first light source element.

4. The lighting device according to claim 1, wherein
the light source includes a housing portion housing the first and second light source elements, and
the housing portion is filled with a fluorescent material configured to subject the outgoing light of at least one of the first and second light source elements to wavelength conversion.

5. The lighting device according to claim 4, wherein
the first light source element is a blue LED configured to emit blue light,
the second light source element is an infrared LED configured to emit infrared light, and
the fluorescent material converts the blue light into white light.

6. The lighting device according to claim 1, comprising a reflective layer disposed between the first and second light source elements, and configured to reflect light.

7. A display device comprising:
the lighting device according to claim 1; and
a display panel configured to display a pixel by using light radiated from the lighting device.

8. The display device according to claim 7, wherein the display panel comprises a liquid crystal panel.
